(19) United States
(12) Patent Application Publication
(10) Pub. No.: US 2024/0424468 A1
(43) Pub. Date: Dec. 26, 2024

(54) ROTATIONAL PLASMA GENERATOR AND METHODS FOR TREATING THIN-FILM FLUIDS

(71) Applicant: AA Plasma LLC, Philadelphia, PA (US)

(72) Inventors: Gregory Fridman, Philadelphia, PA (US); Charles Christopher Bailey, III, Philadelphia, PA (US)

(21) Appl. No.: 18/264,498

(22) PCT Filed: Feb. 8, 2022
(86) PCT No.: PCT/US2022/070568

§ 371 Date: Aug. 7, 2023

Related U.S. Application Data
(60) Provisional application No. 63/199,988, filed on Feb. 8, 2021.

(51) Int. Cl. B01J 19/08; H05H 1/24

(52) U.S. Cl. CPC B01J 19/088; H05H 1/2431; B01J 2219/0809; B01J 2219/0815; B01J 2219/0818; B01J 2219/083

(57) ABSTRACT

A plasma generating device comprising: a cylindrical rotational electrode situated lengthwise on a rotating shaft connected to a motor, the rotational electrode disposed over a reservoir and having a contact portion extending into the reservoir; one or more static electrodes held in proximity to the rotational electrode to generate a plasma therebetween when a sufficient voltage difference exists between the static electrodes and the rotational electrode, the sufficient voltage difference created by a high voltage generator connected directly or indirectly to the static electrodes, the rotational electrode, or both; and a dielectric material situated between the rotational electrode and the static electrodes, the dielectric material having a sufficient thickness to prevent a short-circuit between the rotational electrode and the static electrodes yet a minimal thickness to allow the plasma to be generated between the rotational electrode and the static electrodes.

### CROSS-REFERENCE TO RELATED APPLICATIONS

This application is a 371 National Phase Entry of International Patent Application No. PCT/US2022/070568 filed on Feb. 8, 2022, which claims the benefit of U.S. Provisional Patent Application No. 63/199,988 filed on Feb. 8, 2021, with the United States Patent and Trademark Office, the contents of which are incorporated herein by reference in their entirety.

### FIELD OF THE INVENTION

The invention is related to a device for treating thin-film fluids and generating volumes of plasma-treated fluids, as well as methods for using the same for treating said fluids and creating volumes of plasma-treated fluids. Methods herein are related to the scaling up production of plasma-treated fluids through devices creating thin-film fluids.

### BACKGROUND OF THE INVENTION

Plasma-treated fluids have certain unique properties based on the introduction of certain reactive species and radicals into the fluid. Within the prior art, single electrodes are utilized to create low volumes of fluid that are plasma-treated. A high voltage electrode, typically with a quartz glass barrier, ceramic barrier, or other dielectric barrier, is positioned at a specific distance from a fluid. The fluid, upon application of an electric field will jump to the electrode and charge the fluid.

However, it is critically important to manage the distance between the electrode and the fluid to prevent the fluid from jumping to the electrode and grounding the electrode. It is also important to control interaction of the fluid with plasma to maximize diffusion of plasma-generated reactive species and radicals into the fluid. Furthermore, as a single electrode, the volume which can be treated is small. Grids of electrodes may be utilized over a flat span of fluids, but again issues relate to the distance between the electrode and the fluid and to create such stable and level spaces for treating the fluid without spoiling the fluids. Accordingly, mass production of such fluids is all but impossible.

The present disclosure addresses these and other limitations in the prior art to create a new device and methods for treating thin-film fluids and related methods for mass production of large volumes of plasma-treated fluids.

### SUMMARY OF THE INVENTION

In preferred embodiments, a device for generating a plasma-activated water comprises a static electrode and a rotational electrode; wherein a voltage difference between the static electrode and the rotational electrode is sufficient to generate plasma; and comprising a dielectric barrier positioned between said static electrode and said rotational electrode. In preferred embodiments, a dielectric material coats one or both of the static electrode and the rotational electrode, and a reservoir with a fluid is positioned so as to allow the rotational electrode to contact the fluid within the reservoir, and by rotation of the rotational electrode, positions a thin film of fluid on said rotational electrode, wherein the thin film of fluid is contacted by plasma as it passes through the generated plasma generating a plasma-treated fluid.

In a preferred embodiment, a method of generating a plasma-activated water comprising: rotating a dielectric assembly within a fluid filled reservoir, said fluid filled reservoir comprising a volume of fluid, preferably water; creating a charge over at least one static electrode, said static electrode in proximate distance to said dielectric assembly; transferring the fluid from said reservoir to said rotating dielectric assembly by contacting said rotating dielectric assembly to said fluid; and applying plasma generated by the voltage between said static electrode and said dielectric assembly to said fluid creating the plasma-activated water. In a preferred embodiment, wherein the plasma-activated water is frozen or flash frozen after contacting by said plasma.

In a preferred embodiment, a plasma generating device comprising: a static electrode and a rotational electrode; a dielectric positioned therebetween said static electrode and said rotational electrode; and a high voltage generator connected to at least one of the static electrode or rotational electrode.

In a further embodiment, the plasma generating device further comprising a fluid reservoir, said fluid reservoir positioned below said rotational electrode. In a further embodiment, the plasma generating device further comprising a motor, said motor operationally linked to said rotational electrode.

In a further embodiment, the plasma generating device wherein said dielectric is positioned on said static electrode or said rotational electrode.

In a further embodiment, the plasma generating device comprising a shaft along a longitudinal axis of said rotational electrode, and wherein said shaft is operationally connected to said motor.

In a further embodiment, the plasma generating device wherein the high voltage generator defines a voltage difference of between and including 500 volts and 200,000 volts across the static electrode and the rotational electrode sufficient to generate plasma.

In a further embodiment, the plasma generating device comprising at least two static electrodes, each positioned along a longitudinal axis of said rotational electrode.

In a further embodiment, the plasma generating device wherein said rotational electrode is a cylindrically shaped rotational electrode.

In a further embodiment, the plasma generating device wherein said static electrode is arcuate shaped, said arcuate shape being defined by the size and shape of the cylindrically shaped rotational electrode.

In a further embodiment, the plasma generating device further comprising a static electrode holder, which is adjustable to optimize position of the static electrode in proximity to the rotational electrode for the formation of plasma.

In a further embodiment, the plasma generating device wherein said fluid reservoir comprises a volume of fluid, said volume of fluid sufficient such that the rotational electrode is in contact with at least a portion of said fluid.

In a further embodiment, the plasma generating device wherein a fluid moving element is positioned on said rotational electrode.

In a further embodiment, the plasma generating device wherein said dielectric defines a plurality of ridges, said plurality of ridges being substantially aligned along the longitudinal axis of the rotational electrode.

In a further embodiment, the plasma generating device wherein said fluid is selected from the group consisting of: water, an oil, an alcohol, an epoxy, a paint, a polymer, a mixture of polymers, and combinations thereof.

In a further embodiment, use of the plasma generating device for generating a quantity of plasma treated fluid.

In a preferred embodiment, a plasma generating device comprising: a cylindrical rotational electrode situated lengthwise on a rotating shaft connected to a motor, the rotational electrode disposed over a reservoir and having a contact portion extending into the reservoir; at least one static electrode held in proximity to the rotational electrode to generate a plasma therebetween when a sufficient voltage difference exists between the at least one static electrode and the rotational electrode, the sufficient voltage difference created by a high voltage generator connected directly or indirectly to the at least one static electrode, the rotational electrode, or both; and a dielectric material situated between the rotational electrode and the at least one static electrode, the dielectric material having a sufficient thickness to prevent a short-circuit between the rotational electrode and the at least one static electrode yet a minimal thickness to allow the plasma to be generated between the rotational electrode and the at least one static electrode.

In a further embodiment, the plasma generating device wherein the at least one static electrode is held by an electrode holder in an arcuate shape to maintain equidistance between the at least one static electrode and the rotational electrode. In a further embodiment, the plasma generating device wherein there is a single static electrode having an arcuate shape that complements a cylindrical surface of the rotational electrode to maintain equidistance between the single static electrode and the rotational electrode. In a further embodiment, the plasma generating device wherein there are three or more static electrodes, each static electrode being an elongate rod held by the electrode holder to form the arcuate shape, each elongate rod separated from the other by the electrode holder.

In a further embodiment, the plasma generating device wherein the dielectric material is disposed on the rotational electrode, the at least one static electrode, or both.

In a further embodiment, the plasma generating device further comprising a sidewall having a bearing disposed therein to rotationally support an end of the rotating shaft that extends through the bearing and that is opposite an end connected to the motor.

In a further embodiment, the plasma generating device wherein the rotational electrode includes a fluid moving element selected from the group consisting of: a bucket-ended paddle, a fin, a raised ridge, and combinations thereof; the fluid moving element positioned on or adjacent to the rotational electrode and radiating out from the rotational electrode.

In a further embodiment, the plasma generating device wherein the contact portion is placed to contact a fluid in the reservoir so that when the rotational shaft rotates the rotational electrode, a cylindrical surface of the rotational electrode carries a portion of the fluid out the reservoir as long as the rotational electrode continues to rotate. In a further embodiment, the plasma generating device further comprising a blade oriented proximate the rotational electrode to divert the fluid for collection after the fluid has passed through the plasma.

In a further embodiment, the plasma generating device further comprising a treatment area generally defined by the length and diameter of the rotating electrode and the length and the width of the arcuate shape that maintains equidistance between the at least one static electrode and the rotational electrode, and a treatment speed generally determined by the speed at which the rotating shaft is moving. In a further embodiment, the plasma generating device further comprising a plasma dosage, said plasma dosage defined at least in part by the voltage difference, a speed of the rotating shaft, a surface area of the rotational electrode, and the treatment area.

In a preferred embodiment, a method of generating a plasma-treated fluid comprising: providing a fluid to a reservoir; rotating a rotational electrode through the fluid in the reservoir to continuously deliver a portion of the fluid through a plasma treatment area created by a voltage difference between the rotational electrode and at least one static electrode that is positioned adjacent to the rotational electrode to maximize the plasma treatment area; and accumulating a generated plasma-treated fluid that is the result of rotating the portion of the fluid through the plasma treatment area.

In a further embodiment, the method further comprising creating a voltage difference between the rotational electrode and the at least one static electrode by applying a voltage to the rotational electrode, the at least one static electrode, or both so that the voltage difference is a voltage difference between and including 500 volts and 200,000 volts. In a further embodiment, the method wherein applying a voltage comprises pulsing the voltage between and including 10 Hz and 40,000 Hz with an amplitude of between and including 5 kV to 50 kV.

In a further embodiment, the method wherein the rotational electrode is cylindrical and further comprising positioning the at least one static electrode to complement a cylindrical surface of the rotational electrode and to maximize the plasma treatment area by arcing over the cylindrical surface to maintain an equidistance between the at least one static electrode and the cylindrical surface of the rotational electrode throughout the arc.

In a further embodiment, the method wherein accumulating the plasma-treated fluid comprises either returning the plasma-treated fluid to the reservoir to intermix with the fluid already in the reservoir or diverting the plasma-treated fluid to a collection container.

In a further embodiment, the method wherein providing a fluid to the reservoir includes providing a fluid containing an additive that will produce a plasma-treated fluid having a desired property. In a further embodiment, the method wherein the additive is selected from the group consisting of: peracetic acid, a chlorine-based disinfectant, an alcohol, hydrogen peroxide, sodium nitrate, and combinations thereof.

In a further embodiment, the method wherein the additive provides a plasma-treated fluid that, when applied to a substance harboring E. coli is able to kill the E. coli at a rate that is greater than 1-log reduction compared to a same fluid without the additive. In a further embodiment, the method further comprising using the plasma-treated fluid by applying the plasma-treated fluid to a substrate, and thereafter collecting the used plasma-treated fluid for eventual recycling to the reservoir.

In a further embodiment, the method wherein the additive is selected from the group consisting of: peracetic acid, a chlorine-based disinfectant, an alcohol, sodium nitrate, hydrogen peroxide, and combinations thereof; and wherein the additive has a concentration of between and including 0.1 mM and 5 M, or if the additive is hydrogen peroxide it has a concentration of between and including 0.1% and 10%. In a further embodiment, the method wherein the additive is sodium nitrate at a concentration of between and including 1 mM and 100 mM or the additive is peracetic acid and hydrogen peroxide.

In a further embodiment, the method wherein the generated plasma-treated fluid has a pH of between and including 2 and 5 after passing through the plasma treatment area.

In a further embodiment, the method wherein the generated plasma-treated fluid has a concentration of nitrate between 20 ppm and 250 ppm, a concentration of hydrogen peroxide between 10 ppm and 100 ppm, or both.

In a further embodiment, the method wherein the plasma treatment area comprises plasma.

In a further embodiment, the method comprising collecting a portion of plasma-treated fluid by diverting a portion of the plasma-treated fluid with a blade oriented adjacent to the rotational electrode and downstream of the plasma treatment area and causing a portion of the plasma-treated fluid to be diverted across the blade for collection.

In a preferred embodiment, a device for large scale generation of a plasma to treat a fluid comprising: a treatment area having a length and a width defined by a size of a rotational electrode and the size of either one static electrode or the length of a static electrode in a plurality of static electrodes and the collective width created by the plurality of static electrodes when situated adjacent to the rotational electrode in sufficient proximity to enable a plasma to form between the rotational electrode and either the one static electrode or the plurality of static electrodes, the plasma in the treatment area created by providing a voltage difference between the rotational electrode and either the one static electrode or the plurality of static electrodes; a dielectric material between the rotational electrode and either the one static electrode or the plurality of static electrodes, the dielectric material of sufficient thickness to prevent a short-circuit from occurring between the rotational electrode and either the one static electrode or the plurality of static electrodes yet of minimal thickness to allow the plasma to be created within the treatment area; a rotating shaft having the rotational electrode positioned thereon, the rotating shaft connected to a motor that enables the rotational electrode to move at a selected speed; and a reservoir positioned below the rotational electrode, the reservoir to hold a volume of fluid so that a portion of the fluid is lifted from the reservoir and carried through the treatment area by the rotational electrode as the rotational electrode moves at the selected speed.

In a further embodiment, the device wherein the size of the treatment area is altered by changing the size of the rotating electrode, by changing the size of the one static electrode, by changing the length of the static electrode in the plurality of static electrodes, by changing the number of static electrodes in the plurality of static electrodes, by maximizing the treatment area by providing a cylindrical rotating electrode and by arcing either the one static electrode or the plurality of static electrodes over a curved surface of the cylindrical rotating electrode so that either the one static electrode or the plurality of static electrodes are equidistant from the curved surface of the cylindrical rotational electrode, or combinations thereof.

In a further embodiment, the device wherein changing the selected speed changes the time in which the portion of fluid is exposed to the treatment area and changing the voltage difference between the rotational electrode and either the one static electrode or the plurality of static electrodes changes the degree to which the portion of fluid is affected by the plasma in the treatment area.

In a further embodiment, the device wherein the fluid is selected from the group consisting of: water, an oil, an alcohol, an epoxy, a paint, a polymer, a mixture of polymers, and combinations thereof.

### BRIEF DESCRIPTION OF THE FIGURES

FIG. 1 details an embodiment of a plasma generating device.

FIG. 2 details an embodiment of a plasma generating device.

FIG. 3 details an embodiment of a plasma generating device.

FIGS. 4A, 4B, and 4C detail variations of dielectrics comprising water moving elements.

FIG. 4D details an embodiment of a dielectric.

FIG. 5 details an embodiment comprising two dielectrics on a rotating shaft.

FIGS. 6A and 6B detail different orientations of several electrodes, with FIG. 6A depicting three electrodes around a dielectric and FIG. 6B depicting five electrodes around a dielectric. FIG. 6C details the use of an arcuate static electrode positioned above the dielectric assembly. FIG. 6D depicts an arcuate static electrode with a dielectric barrier positioned between said static electrode and said dielectric assembly.

FIGS. 7A and 7B depict embodiments using a blade to remove plasma-treated water to a separate vessel.

FIG. 8 is a flowchart depicting an embodiment of a method of treating a fluid using an embodiment of a plasma generating device.

### DETAILED DESCRIPTION OF THE INVENTION

The present disclosure details a new device for creating plasma-treated fluids, as well as methods of performing the same. Plasma-treated fluids have unique properties in that the fluids are charged with numerous reactive species and radicals from plasma treatment and the formation of these radicals provides numerous potential beneficial uses. The plasma-treated fluids have been demonstrated as powerful disinfectants in both medical and agricultural industries. Plasma-treated fluids were shown to dissolve rock during mining and drilling operations. Plasma-treated fluids are used in the medical field as a strong oxidizer to stimulate immune response in the host tissue, promoting antitumor effects and decreasing tumor volume. Among many other reported uses, plasma-treated fluids were also demonstrated to stimulate hair follicle stem cells to promote hair regrowth in human patients.

Plasma-treated fluids are often used in wound care, for example, where sterile water is used to clean a wound. However, plasma-treated fluids could go a step further and provide water or another fluid that is charged with reactive species and radicals which could further disinfect or oxidize tissue, bacteria, viruses, etc., in order to thoroughly clean a skin surface. To date, it is impractical to create sufficient volumes of fluids for practical use, despite the potential benefits. Accordingly, the device herein allows for scaled production of such fluids to meet such need in a practical manner.

This same concept can be applied in the agricultural space, where water or other cleaning fluids (often containing bleach or other similar chlorine containing cleaning agents) can be utilized to flush and clean the surface of picked produce, which would then cleanse the surface and remove spores, bacteria, fungi, and the like, in order to prolong shelf life of the product.

In meat preparation, plasma-treated fluids can be again utilized to cleanse meat and remove bacterial and viral loads from the tissue surface and volume of processed tissue. Plasma treatment was shown to have synergetic effect with peracetic acid, dissolved in water and used as a disinfectant in fish, poultry, meat, and fresh produce washing.

The fluids suitable for use with these methods include not just water and water with additives (peracetic acid, chlorine-based disinfectants, alcohols, hydrogen peroxide, etc.), but also other fluids like oils and alcohols. One can even treat polymer mixtures (epoxies, paints, etc.) to promote crosslinking, prepare the paint for use, and add oxidizers into the paint, making it antimicrobial. These materials are able to be made in commercially reasonable quantities through a unique device and methods of manufacture.

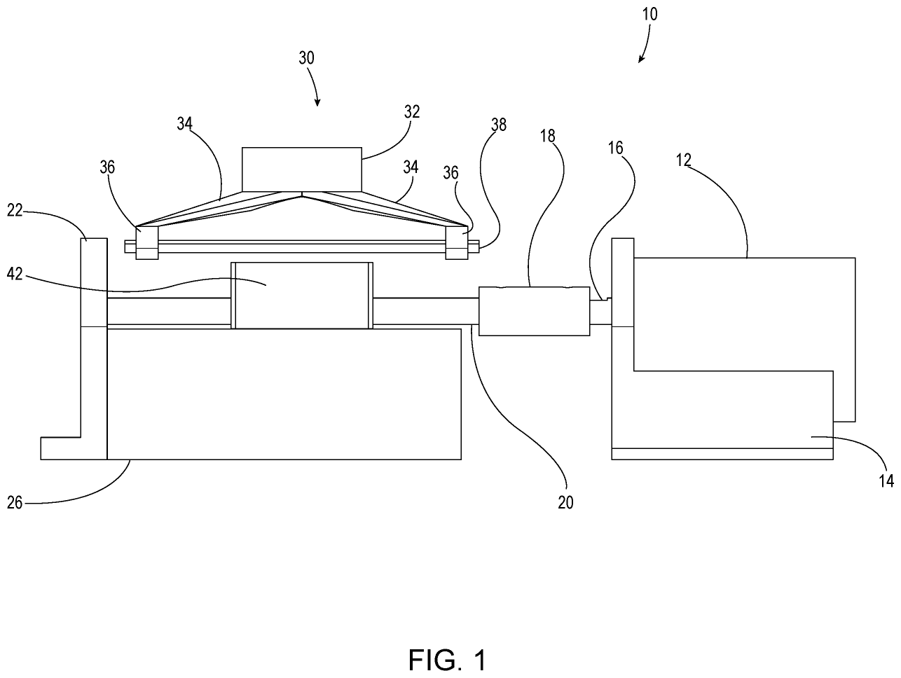

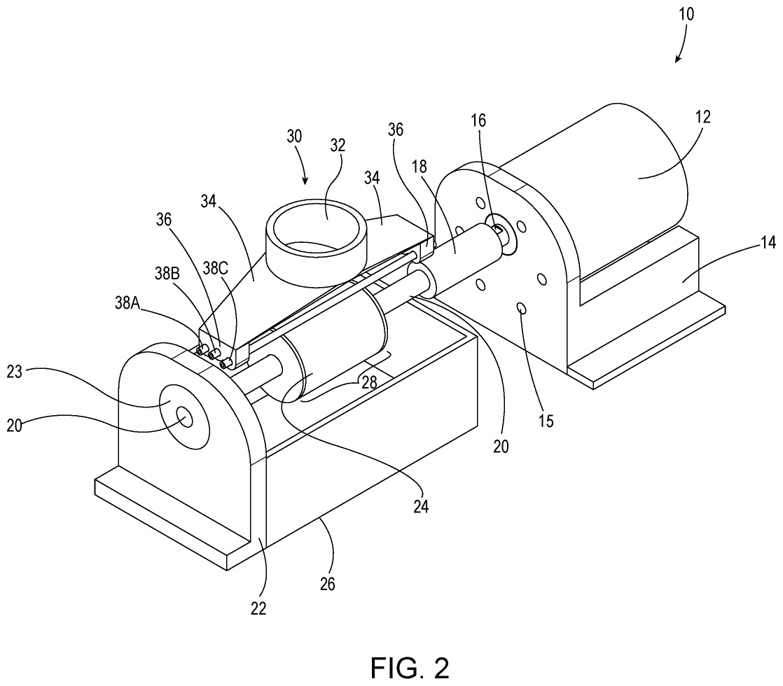

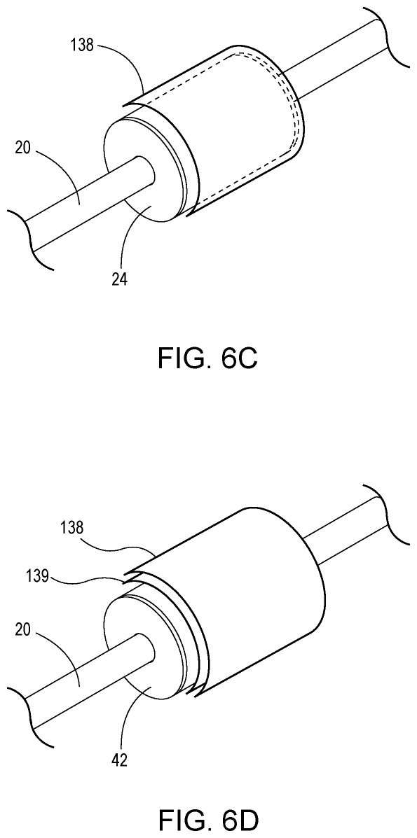

As is shown in FIG. 1 an embodiment of a plasma generating device (10) can include a motor (12), a support structure (14), an output shaft (16), a connector (18), a rotating shaft (20), a sidewall (22), and a rotational electrode (42). Embodiments of the plasma generating device (10) may also include an electrode holder (32), which includes at least one extension arm (34) having a spacer (36) at an end of the extension arm (34). The spacer (36) may hold one or more static electrodes (38) away from the extension arm (34). Embodiments of the plasma generator (10) may also include a reservoir (26) to hold a fluid. As is shown in FIGS. 1 and 2, the reservoir (26) is attached to the sidewall (22), but embodiments are not so limited. FIG. 1 particularly shows the rotational electrode (42), while FIG. 2 depicts a dielectric assembly (24). Notably, a dielectric barrier, either on the dielectric assembly (24), or on the static electrode (38) or as a dielectric sheet barrier (139), as depicted in FIG. 6D must be present to prevent shorting between the two electrodes in order to generate plasma.

Referring to FIGS. 1 and 2, the motor (12) may be any suitable motor that can rotate the output shaft (16) in either a clockwise or a counterclockwise direction. The motor (12) may be electric, although embodiments are not so limited. Further, the motor (12) may be manually powered on or off or it may be associated with a timer or program to turn the motor (12) on and off. Depending on the motor (12) it may be mounted on a support structure (14) to elevate the motor (12) to a desired height, to provide stability, or for any other reason, including aesthetics. In one nonlimiting example, the motor (12) may be mounted to the support structure (14) with one or more screws (15). In some instances, the mechanism for attaching the motor (12) to the support structure (14) may depend on the function of the support structure (14).

In an embodiment, the motor (12) may include an output shaft (16) to transfer mechanical energy to the rotating shaft (20) via the connector (18). Alternatively, a separate output shaft (16) may be connected to the motor (12). Either way, in embodiments utilizing a support structure (14), the output shaft (16) extends through an aperture in a wall of the support structure (14) to connect to an end of the connector (18). The other end of the connector (18) connects to the rotating shaft (20), which extends therefrom. Because of the connection (via connector [18]) between the output shaft (16) and the rotating shaft (20), the two rotate as if a single element. The connector (18) may be made of any suitable material and may include any suitable parts (e.g., screws, bolts, adhesives, and the like) to enable connecting the output shaft (16) and the rotating shaft (20). In an embodiment, however, the connector (18) is made from an insulating material such as, without limitation, rubber, plastic, glass, ceramic, porcelain, or combinations thereof to serve as an insulator when the rotating shaft (20) is utilized as an electrical ground.

In certain embodiments, the device is arranged such that said rotating shaft (20) is connected to said motor (12), directly or through a gear, or belt or other drive mechanism to modify the rate of rotation of the dielectric assembly. Thus, instead of a direct drive assembly, such gear or belt or drive assembly can be used to modify the resulting rotational speed of the dielectric assembly.

The rotating shaft (20), as is shown in FIGS. 1 and 2, extends lengthwise from the connector (18) and through the sidewall (22). The sidewall (22) is separated from and opposite to the support structure (14) so that it is parallel to the wall of the support structure (14) to which the motor (12) is attached. Alternatively, the sidewall (22) may take on any configuration or orientation that allows for rotational support of the rotating shaft (20). In an embodiment, the rotating shaft (20) is supported by at least one bearing (23), such as a ball bearing or series of ball bearings, which is situated within the sidewall (22). The bearing (23) also allows the rotating shaft (20) to smoothly rotate within the sidewall (22). Thus, each end of the rotating shaft (20) is supported to enable smooth, precise rotation. Although the rotating shaft (20) may be made from any suitable material, in certain embodiments, such as where the rotating shaft (20) is used as an electrical ground, the preferred material is a metal or other conductive material.

The device functions by the lifting of water onto a rotating electrode (42), which creates a thin film of fluid. That thin film of fluid is then passed through and into contact with plasma generated by the combination of the static and rotating electrode and a sufficient voltage. Thus, the fluid must be in contact with at least a portion of the rotating electrode (42) to generate the thin film. Referring to FIGS. 1 and 2, the reservoir (26) abuts the sidewall (22) and extends toward the motor (12) and support structure (14) so that it is situated below at least a portion of the rotating shaft (20), although embodiments are not so limited. The reservoir (26) may be integral with, detachable, or separated from the sidewall (22). Further, the reservoir (26) is sized and shaped to hold a quantity of fluid to be treated by the device (10) for generating plasma treated fluids. Thus, in certain embodiments, the reservoir (26) may be made from a material that is suitable for containing a particular type of fluid. There are a wide variety of fluids that may be treated by the plasma generating device (10). For example, treatable fluids include, without limitation, water, oils, alcohols, hydrogels, epoxies, paints, polymers, and the like. Similarly, a wide variety of additives may be added to a treatable fluid. The type of additive may depend on the fluid to be treated and the desired outcome. As one nonlimiting example, antimicrobials, antifungals, oxidizers, pigments or other colorants, and the like may be added to treatable polymers/polymer mixtures (e.g., epoxies, paints, etc.). As another nonlimiting example an additive may be added to a polymer/polymer mixture to promote crosslinking, prepare it for use, or any other desired outcome. As another nonlimiting example, additives such as sodium nitrate, peracetic acid, chlorine-based disinfectants, alcohols, hydrogen peroxide, and many other additives and combinations of additives may be added to water and treated by the device (10). Typically, such additives are included at between 0.01 mM and 5 M. Hydrogen peroxide is often provided in quantities of percentage as a 0.01% to 10% hydrogen peroxide mixture with the fluid, often being water.

In certain applications, the inclusion of a radical donor is especially warranted. A radical donor is a material that, in the presence of the plasma, generates high quantities of highly reactive oxidizing radicals. In fact, a particularly useful embodiment of a treated fluid includes water having a sodium nitrate added thereto at a concentration of 25 millimolar (mM). Sodium nitrate, when in the presence of plasma, generates high concentrations of peroxynitrate, which is a very strong oxidizer. Similar material may be included as a radical donor to increase the concentration of these very strong oxidizers to create fluid mixtures that have greater oxidation potential than without inclusion of such material. A highly preferred additive is a combination of two or more additives, for example sodium nitrate at 0.1 to 250 mM and hydrogen peroxide at 0.01% to 10% concentration.

The size, shape, and placement of the reservoir (26) may also be determined by the rotational electrode (42) or the dielectric assembly (24). For simplicity, the rotational electrode (42) may be covered with a dielectric material (40) creating the dielectric assembly (24). As detailed herein, these can be exchanged for one another, so long as a dielectric is positioned in some location, either on the static electrode or as a sheet barrier to prevent shorting of the electrodes. For example, the rotational electrode (42) or dielectric assembly (24) is typically cylindrical having a length and a radius. Both the length and the radius of the rotational electrode (42) can be independently modified over a wide range of sizes. Thus, the rotational electrode (42) can be long and skinny, short, and fat, and numerous variations thereon. In turn, the size and shape of the reservoir (26) should be compatible with the dimensions of the rotational electrode (42). Generally, however, the reservoir (26) is longer and wider than the rotational electrode (42) and is located beneath the rotational electrode (42) as is shown in FIG. 1 and under the dielectric assembly in FIG. 2.

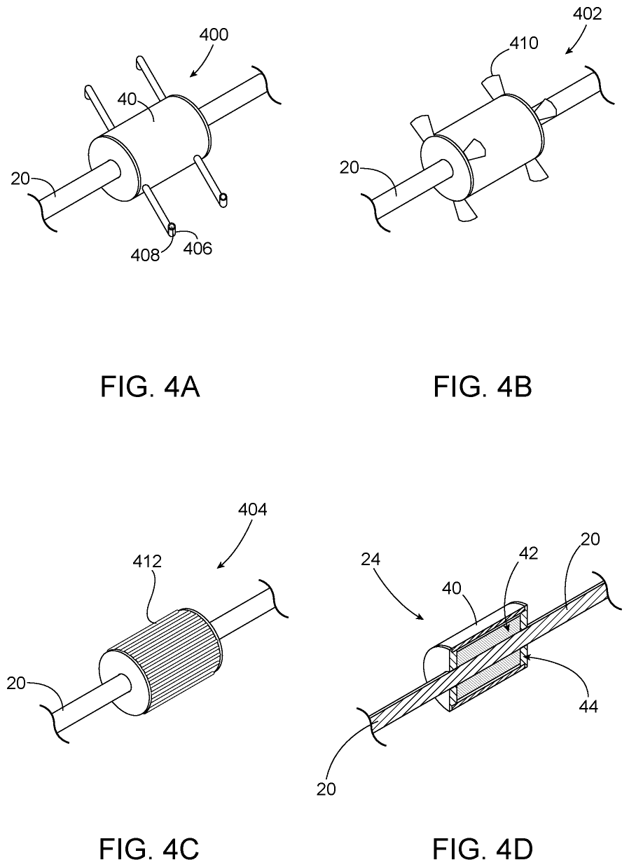

The rotational electrode (42) is also positioned on the rotating shaft (20) so that the rotating shaft (20) and the rotational electrode (42) are aligned along their respective lengths or longitudinal axis. In other words, the rotating shaft (20) is oriented on a longitudinal axis of the rotational electrode (42). In preferred embodiments, the rotational electrode (42) is coated with a dielectric. Referring to FIG. 4D, a sectional view of an embodiment of the dielectric assembly (24) includes a portion of the rotating shaft (20), a rotational electrode (42), a dielectric (40) material, such as quartz or a resin based material that can be secured around the rotational electrode (42) to provide a consistent diameter and also an electrical barrier. An adhesive (44) (which functions as a dielectric), can also be utilized in addition to or replacing the quartz or resin-based material. As can be seen in this view, the diameter of the dielectric assembly (24) as a whole is consequentially greater than the diameter of the rotating shaft (20) and the rotational electrode (42). In an embodiment, the rotational electrode (42) is a metal core within the dielectric (40) that is connected to the rotating shaft (20). The adhesive (44) surrounds the rotational electrode (42) or just the ends of the electrode to protect it from fluid in the reservoir (26). The dielectric (40) also covers and protects the rotational electrode (42). Thus, in a preferred embodiment, the length of the dielectric (40) material is longer than the length of the rotational electrode (42) so that it can surround and protect the rotational electrode (42). However, the length of the dielectric (40) material, and hence that of the rotational electrode (42), is preferably less than that of the rotating shaft (20).

The rotational electrode (42) may be any suitable metal, but in a particular embodiment it is copper. Likewise, the adhesive (44) may be any suitable adhesive, such as a silicone or a UV cured epoxy. Additionally, the dielectric (40) may be any suitable dielectric material for a particular application such as glass, quartz, ceramic, and quartz glass as a few nonlimiting examples and it may be intended for a single use, for multiple uses, or for constant use. In embodiments where the dielectric (40) and adhesive (44) are made from a transparent or translucent material, the rotational electrode (42) may be visible through the dielectric (40) and adhesive (44). Furthermore, depending upon the material that the dielectric (40) is made from, among other factors, the curved outer surface of the dielectric (40) may be visually and/or tactilely smooth, or have certain patterns or ridges to aid in the movement of fluids.

Preferably, the dielectric (40) has a thickness of between 100 microns and 5 millimeters. The thinner dielectric (40) is often more expensive to manufacture and thus it may be advantageous to focus on materials between 500 microns and 3 millimeters. Once the thickness of the dielectric (40) is greater than about 5 millimeters, the creation of plasma between the static electrode (38) and the dielectric assembly (24) becomes difficult. Notably, each of the dielectric assembly (24) and the static electrode (38) may contain a dielectric coating or barrier, which function to prevent shorting of the static electrode (38) and the rotational electrode (42) as the high voltage is applied to generate plasma. Indeed, a glue or adhesive, such as a resin or epoxy may be utilized where any potential metallic portion of either the static electrode (38) or the rotational electrode (42), so as to prevent shorting. Even the presence of bubbles or microscopic holes in the materials is suitable to create a short at the high voltages. Thus, in preferred embodiments, complete coverage of at least one of the rotational electrodes (42) or static electrode (38) is necessary.

Referring back to FIGS. 1 and 2, when the motor (12) is powered on, it rotates the rotating shaft (20), and the rotating shaft (20) rotates the rotational electrode (42) or dielectric assembly (24). Further described is use with the dielectric assembly (24), though it is interchangeable with the rotational electrode (42) assuming use of a dielectric between the rotational electrode (42) and the static electrode (38). At least a portion (28) of the dielectric assembly (24) sits below the top of the reservoir (26) so that dielectric assembly (24) extends into the reservoir (26) to contact the fluid within the reservoir (26). Thus, due to the rotation of the rotating shaft (20), the dielectric assembly (24) also rotates (along its longitudinal axis) so that the outer surface of the dielectric assembly (24) can continuously contact and lift the fluid contained by the reservoir (26) as will be further described.

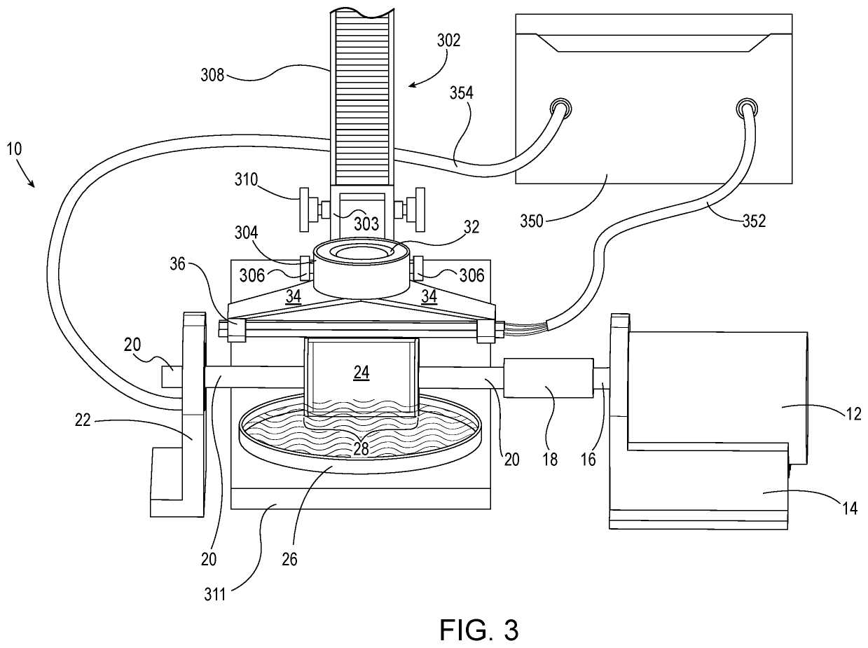

An embodiment of the z-position electrode holder (30) shown in FIGS. 1 and 2 includes a holder connector (32) that is attached to and extends upwardly from at least one angled extension arm (34). The holder connector (32) connects the electrode holder (30) to a lifting device, which will be described in connection with FIG. 3. This embodiment of the extension arm (34) radiates outward and downward from the holder connector (32), although embodiments are not so limited. At the end of each extension arm (34) shown in the figures is a downwardly depending spacer (36). Each spacer (36) has an aperture sized to hold an end of a static electrode (38) so that the static electrode (38) extends between the spacers (36) and away from the extension arms (34). The exact size and shape of the electrode holder (30) and its component parts may depend on many factors, some of which are discussed herein. Other factors that may contribute to the size and the shape of the electrode holder (30) that are not discussed in detail, but may still influence the design of the electrode holder (30) include, but are not limited to, the application in which the plasm-generating device (10) is being used, the type and configuration of the lifting device, and other situational/environmental factors that would be appreciated by one skilled in the art. Furthermore, the electrode holder (30) may be made from any suitable material and in any suitable way. As one nonlimiting example, the electrode holder (30) may be molded in one or more pieces from an insulating material such as a plastic or other polymer. In an embodiment, at least the spacers (36) are formed from an insulating material to separate, insulate, and orient one or more electrodes (38).

As has been alluded to, the electrode holder (30) may be lifted and lowered; as such, so is the static electrode (38). In an embodiment, the static electrode (38), via the electrode holder (30), is situated at a desired distance adjacent to the dielectric assembly (24) or rotational electrode (42). As can be seen in FIG. 1, the length of the static electrode (38) is optimally positioned parallel to the longitudinal axis of the rotating shaft (20) and the rotational electrode (42), and it has a length that is longer than the rotational electrode (42) and shorter than the rotating shaft (20), although embodiments are not so limited. In an embodiment where a single static electrode (38) is positioned adjacent to the rotational electrode (42), and the static electrode (38) is provided with a current, as will be described herein and is understood by those of ordinary skill in the art, a small amount of electric discharge (plasma) is generated along the length of the static electrode (38). As a voltage may be applied across the static electrode (38), it is typically made from a suitable conductive material such as a metal, metal alloy, carbon-based material, metal oxide, and the like. In an embodiment, the one or more static electrodes (38) may be coated with a dielectric material that is the same as or similar to the dielectric material of the dielectric assembly (24). Further, although the static electrode (38) shown herein is cylindrical, having a length and a diameter, embodiments are not so limited. The static electrode (38) may have any shape that enables its function as described herein. In fact, an alternative embodiment is shown in FIG. 6C.

Although reference has been made to one static electrode (38), a preferred embodiment of the plasma generating device (10) includes more than one static electrode (38), as is shown in FIGS. 2, 6A, and 6B, where FIGS. 6A and 6B depict a front profile of a dielectric assembly (24) surrounded by three (FIG. 6A) or five (FIG. 6B) electrodes (38), similar to that of FIG. 2. These figures show the electrodes (38) oriented around the dielectric assembly (24) in an arcuate shape. As such, the structure of the electrode holder (30) is adapted to hold a desired number of electrodes (38) equidistant and adjacent to the dielectric assembly (24). For instance, referring to FIGS. 2 and 6A, the electrode holder (30) is adapted to hold three electrodes (38A, 38B, and 38C). Specifically, the dimensions of the extension arms (34) and associated spacers (36) are adapted to hold the three electrodes (38A, 38B, and 38C). Thus, each spacer (36) has three apertures sized and positioned to hold the electrodes (38A, 38B, and 38C) therebetween. Notably, the apertures separate the electrodes (38A, 38B, and 38C) so that the spacer (36) material can insulate each electrode (38A, 38B, and 38C) from the others. In an embodiment, the apertures have an arcuate arrangement so that the electrodes (38A, 38B, and 38C) are maintained an equidistance from the dielectric assembly (24). That said, it should be understood that the arcuate positioning of electrodes (38A, 38B, and 38C) in the electrode holder (30) corresponds to the shape of the dielectric assembly (24) associated therewith. Stated another way, the arcuate arrangement of the electrodes (38A, 38B, and 38C) is dependent on the radius of the dielectric assembly (24). The arcuate arrangement is also dependent upon the thickness of each electrode (38A, 38B, and 38C) and the ability to space the electrodes (38A, 38B, and 38C) to optimize plasma generation between the electrodes (38A, 38B, and 38C) and the dielectric assembly (24).

As is shown in FIG. 6B, an embodiment of the electrode holder (30) is adapted to hold five electrodes (38A, 38B, 38C, 38D, and 38E). As with the electrode holder (30) adapted to hold three electrodes, the five electrode holder (30) positions the electrodes (38A, 38B, 38C, 38D, and 38E) in an arcuate arrangement around the corresponding dielectric assembly (24). Namely, the extension arm (34) and downwardly depending spacers (36) are sized to accommodate the number and size of apertures to hold the number and size of electrodes (38A, 38B, 38C, 38D, and 38E) equidistant from the dielectric assembly (24). Again, as the radius of the dielectric assembly (24) is increased (or decreased), the spacing and the quantity of the electrodes (38) can be increased (or decreased). Furthermore, as the size of individual electrodes (38) is reduced in thickness, additional electrodes (38) can be arranged in a smaller space.

FIGS. 6C and 6D depict a further embodiment, wherein the one or more static electrodes are replaced by an arcuate shaped electrode sheet (138). The electrode sheet (138) preferably has a length and a width that would mirror the total length and width of a plurality of electrodes (e.g., 38A, 38B, etc.). The electrode sheet (138) preferably comprises an arcuate shape to mirror that of the dielectric assembly. The arcuate shape enables a larger surface area for the static electrode and when maintained at an equidistant position to said dielectric assembly enables greater plasma generation than one or more electrodes. Thus, such feature may increase the plasma concentration being generated over the same surface area of the dielectric assembly as compared to use of one or more static electrodes not in the arcuate sheet shape. FIG. 6D further details the inclusion of a dielectric sheet (139). The dielectric sheet (139) allows for a dielectric to be positioned between the arcuate shaped electrode sheet (138), or any static electrode, and the rotational electrode (42). This allows for each of the static electrode (whether arcuate or other shaped) and the rotational electrode (42) to not utilize a dielectric coating, and to simply place this dielectric as a dielectric sheet (139) to prevent any shorting.

As was previously mentioned, when a single static electrode (38) is positioned adjacent to the dielectric assembly (24), and a current is provided to the static electrode (38) a small amount plasma is generated along the length of the static electrode (38). By positioning additional electrodes (38), as depicted in FIGS. 2, 6A, and 6B, adjacent to a complementary dielectric assembly (24) additional plasma coverage is generated, allowing for more fluid to be treated by the device (10). That is, the fluid is treated by plasma through contact, namely, the fluid passes over and around the rotating dielectric assembly (24), and through plasma generated by the electrodes (38). To increase the amount of plasma treatment, the total surface area of plasma treatment can be increased by the increase in the number of electrodes (38). Assuming the dielectric assembly (24) has large enough curved surface, many electrodes (38) can be arranged around the curved surface and equidistantly spaced away from the curved surface of the dielectric assembly (24). Those of skill in the art will recognize and optimize the quantity and spacing of the electrodes (38) in order to create the spread of plasma generation needed for the particular application. Thus, the static electrode (38) arrangement of FIG. 6B gives an even further visualization of how the additional expansion of electrodes (38) can be arranged around the dielectric assembly (24) to increase plasma generation and coverage.

FIG. 3 depicts an embodiment of a plasma generating device (10) that can also be used to generate plasma-treated fluids. The embodiment shown in FIG. 3 is similar to other embodiments in that it includes a motor (12), a support structure (14), an output shaft (16), an output connector (18), a rotating shaft (20), an opposing sidewall (22), a bearing (23), and an electrode holder (30) having a holder connector (32), angled extension arms (34), and downwardly depending spacers (36) that are the same as or substantially similar to those shown in FIGS. 1 and 2. For example, the rotating shaft (20) may be the same rotating shaft as that shown in FIGS. 1 and 2, except in FIG. 3, the end of the rotating shaft (20) may extend beyond the opposing sidewall (22) due to the positioning of the rotating shaft (20) within the sidewall (22). The difference is due to the ability to variably position the rotating shaft (20) along its length with respect to the sidewall (22). In this embodiment, the reservoir (26) and the dielectric assembly (24) are still substantially similar to those shown in FIGS. 1 and 2 even though they appear different in form. For example, the reservoir (26) is depicted as a circular bowl or dish instead of rectangular box and it is separated from the opposing sidewall (22) instead of abutting the sidewall (22). These differences, however, are of form and do not alter the ability of the reservoir (26) to contain a fluid, be positioned under the dielectric assembly (24), and the like. Similarly, the dielectric assembly (24) appears to be longer than the dielectric assembly (24) of FIGS. 1 and 2, especially when compared to the length of the electrodes (38). As such, the contact portion (28) of the dielectric assembly (24) that extends within the reservoir (26), may also be longer than that of dielectric assembly (24), which may affect the amount of fluid being treated. Again, variations in form do not alter the function of the dielectric assembly (24). Taking the forgoing together, one of ordinary skill in the art would understand that various components of the device (10) may be adapted/altered to suit a particular environment, outcome, conditions, and the like, and still be within the scope of the present invention.

A lifting device (302) is also depicted in FIG. 3. The lifting device (302) may be any lifting device capable of moving the electrode holder (30) toward or away from the dielectric assembly (24). As such, the same or similar type of lifting device (302) may be used to position one or more electrodes (38) in other/additional embodiments of the present invention. The lifting device (302) shown in FIG. 3 is well known in the art as are other such lifting devices. Generally, the lifting device (302) includes an adjustable arm (303) having a retaining holder (304) at one end and an aperture at the opposing end. The aperture at the opposing end fits over and complements a toothed, upwardly (in FIG. 3) extending arm holder (308). A wheel (310) is attached to the adjustable arm (303) and is associated with a gear to raise and lower the adjustable arm (303) along the length of the arm holder (308). In this way, anything secured to the adjustable arm (303) such as the z-position electrode holder (30) is also repositionable. As is shown, the holder connector (32) of the electrode holder (30) is shaped to be compatible with the retaining holder (304) at the end of the adjustable arm (303) so that the holder connector (32) may be easily secured within the retaining holder (304) by screws (not shown) associated with knobs (306), although embodiments are not so limited. As one nonlimiting example, the electrode holder (30) may be permanently attached to the end of the adjustable arm (303), and as such may be made integral therewith such as by molding the electrode holder (30) and the adjustable arm (303) as a single piece or by other forms of permanent attachment such as by a permanent adhesive. This type of arrangement, and variations thereon, may be preferred in a large-scale industrial application where an embodiment of the plasma generating device (10) is optimized for the particular industrial application. Alternatively, in relatively small-scale industrial application, the embodiment of the plasma generating device (10) may be optimized by having a plurality of interchangeable parts with various configurations/dimensions to accommodate a host of small-scale applications. Furthermore, embodiments of the lifting device (302) are not limited to an adjustable arm (303) positioned by a wheel and gear mechanism. Any type of adjustable arm (303) may be incorporated into device (10) design such as, without limitation, a hinged arm, a flexible arm, a telescoping arm, a swinging arm, and combinations thereof may all be suitable types of adjustable arms (303). Importantly, the adjustable arm (303) should be capable of raising or lowering the electrodes (38) to allow for variance in the vertical placement of the electrodes (38). This allows for precise control over the distance between the high voltage electrodes (38) held by the electrode holder (30) and rotational electrode (42) associated with the dielectric assembly (24). This also allows to accommodate different diameter electrodes (38). In an embodiment, the lifting device (302) may also optionally include a platform (311) on which the reservoir (26) may be placed. If the lifting device (302) does not have a platform, it may be stabilized another mechanism such as, without limitation, a clamp, or a foot. Although not shown, the platform (311) may include a screw, pin, or the like, to ground the platform during operation.

To generate a nonthermal plasma, a high voltage is applied across the static electrodes (38). As is shown in FIG. 3, a high voltage generator (350) provides the high voltage to the static electrodes (38) via one or more wires/a wiring harness (352) that connects to the high voltage generator (350) and to an end of each static electrode (38). Referring to FIGS. 1 and 2, each end of each electrode (38A, 38B, and 38C) may be exposed by extending through the apertures holding the electrodes (38A, 38B, and 38C). Thus, referring back to FIG. 3, each static electrode (38) held by the electrode holder (30) may be connected to the wire/wiring harness (352). In an embodiment, the voltage provided to the electrodes (38) must be sufficient to generate plasma. As a nonlimiting example, when a charge of 10,000 Hz at an amplitude of 30,000 volts is provided to the one or more static electrode (38), a plasma is generated between the static electrode (38) and the dielectric assembly (24). In a further nonlimiting example, a plasma may be generated by applying a charge over each static electrode (38) and pulsing the voltage between 10 Hz and 40,000 Hz with amplitude of 5 to 50 kV, with a preferred frequency of between 500 Hz and 10,000 Hz and voltage amplitude of between 10 and 50 kV including each respective endpoint. As yet another nonlimiting example, the voltage may be any voltage from 1 kHz to 50 kHz including the endpoints and at an amplitude of from 0.5 kV to 60 kV including the endpoints. Those of ordinary skill in the art will understand and be able to orient one or more electrodes (38), each with a wire/wiring harness (352) or equivalent, to be able to provide voltage over the electrodes (38) so as to create the plasma, even if it diverges from the values herein.

In the simplest manner, the device provides for a static electrode and a rotational electrode, with a dielectric material, whether a coating or a barrier positioned between the two electrodes, and a high voltage generator for application of a high voltage across said at least one static electrode and rotational electrode, which, generates plasma. The formation of plasma is then imparted to the thin-film fluid that has been created by the rotation of the dielectric assembly to generate a plasma-treated fluid.

A second wire/wiring harness (354) is shown in FIG. 3. This wire/wiring harness (354) is attached to the high voltage generator (350) at one end, and at or near the bearing (23) on the other end, although embodiments are not so limited. This second wire/wiring harness (354) is a ground wire/wiring harness (354) to enable grounding of the plasma-generating device (10). For example, the dielectric assembly (24), adhesive, and rotating electrode (as described with respect to FIG. 4D) are positioned on the rotating shaft (20) and attached thereto along the longitudinal axis of the dielectric assembly (24). In a preferred embodiment, the dielectric (40) is a quartz dielectric (40), which covers a copper rotational electrode (42). This copper rotational electrode (42) connects to the (metallic and/or otherwise conductive) rotating shaft (20), which can then act together as the electrical ground. Those knowledgeable in the art will recognize that an electrical connection to earth ground can be made by connecting a conducting wire (e.g., ground wire/wire harness [354]) between the rotating shaft (20) and earth ground in a number of manners to enable the rotation of the rotating shaft (20), while providing an electrical contact to the dielectric assembly (24).

In practice, the plasma generating device (10) functions by providing power to the motor (12), which rotates the rotating shaft (20) and the dielectric assembly (24). Sec, e.g., FIGS. 1, 2, and 3. Since the dielectric assembly (24) is at least partially submerged in the fluid contained by the reservoir (26), (e.g., at contact portion [28]), rotation of the dielectric assembly (24) within the fluid enables the fluid to move within the reservoir (26). Furthermore, the fluid collects onto or is pulled onto the rotating dielectric assembly (24) so that the dielectric assembly (24) is coated with a thin film of the fluid. The thickness of the thin film will vary from fluid to fluid as thickness of the thin film is dependent on the density of the particular fluid being treated, the surface of the dielectric assembly (24), as well as the diameter and the rotational speed. As such, the dielectric assembly (24) moves the thin film of fluid so that the thin film passes through the plasma created by the one or more electrodes (38) held by the electrode holder (30). The surface tension holding the thin film to the dielectric assembly (24), also reduces the chances that the fluid of the thin film from jumping to the electrodes (38) held by the electrode holder (30).

Those knowledgeable in the art will recognize that plasma treatment of the dry electrode will activate the surface of the dielectric assembly, significantly increasing its wettability and aiding in the uniform lift of the fluid from the fluid chamber. When the dielectric assembly is dry, the dielectric material functions as a hydrophobic material. Upon wetting, and the creation of plasma on the dielectric material, the treatment makes the dielectric assembly, particular the surface dielectric (40) hydrophilic. This improves the sheeting of fluid to be pulled from the reservoir by the rotating dielectric assembly.

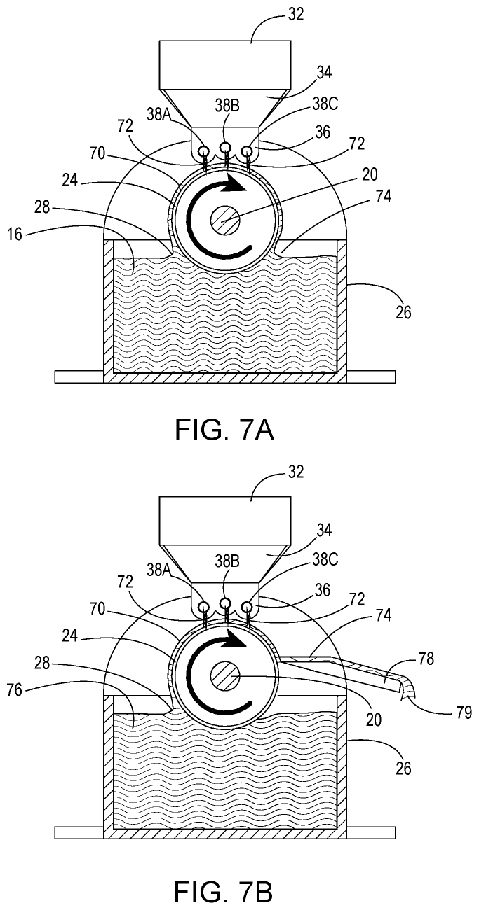

FIG. 7A details in an embodiment of how a fluid may be treated with a plasma produced by the plasma-generating device (10). For example, once the thin film (70), passes the electrodes (38) within a treatment area (72) the thin film (70) becomes a plasma-treated thin film (74). This plasma-treated thin film (74) is then returned to the reservoir (26) and is intermixed with the fluid (76). Because of the rotation of the dielectric assembly (24), certain vortices, or movement of the fluid (76) within the reservoir (26) are created, thus allowing the plasma-treated thin film (74) to intermix and, over the course of a few minutes, treat a quantity of fluid (76) within the reservoir so that the fluid (76) is nearly homogeneously treated with plasma. Where oxidation can occur on materials within the fluid, e.g., bacteria or other material, the now charged radical species will oxidate immediately. Thus, a system utilizing contaminated water (for example, water from a stream in nature), the plasma-treated fluid returned to the reservoir will inactivate pathogens, to create sterile water comprising the various reactive species. Furthermore, it is envisioned that plasma treated fluid may be recycled after use, such as after washing foodstuffs (e.g., produce, meat, etc.), and reprocessed through the device (10) to “self-sterilize” before using again. A simple example would be to create a portion of plasma-treated fluid, apply it to a substrate (a foodstuff or another material benefiting the use of the plasma-treated fluid), allowing the plasma-treated fluid to drain off of the substrate, and collecting the plasma-treated fluid to be recycled back to the reservoir for retreatment by plasma. In this way, industries using large quantities of water may be able to decrease their overall water consumption. By simply collecting wastewater in a drain, such water can be recycled into the reservoir and cleaned for reuse by the device and methods detailed herein.

Upon the passage of a certain amount of time, the fluid (76) within the reservoir (26) is plasma treated to the desired degree and can be removed (e.g., by draining or the like) so that a new quantity of fluid (76) can be added to the reservoir (26) for treatment. Accordingly, a quantity of a fluid (76) can be plasma treated, removed from the reservoir (26), and then packaged or stored for use, while a new quantity of fluid (76) is added to the reservoir (26) and the process repeated. Such a process can be automated by connecting a drain or a pump to the reservoir (26), to remove the plasma-treated fluid, and a fill system to replace the fluid (76) removed from the reservoir (26) with new, untreated fluid. A simple timer or program can be utilized to turn the motor (12) on and off, and/or to control the voltage over the electrodes (38) based on the fluid (76) within the reservoir (26). Thus, by rotating the dielectric assembly (24) in the fluid (76), convection, advection, and diffusion of the fluid (76) allows for a large volume of fluid (76) within the reservoir (26) to ultimately be adjacent to the at least one static electrode (38) thereby treating large volumes of a fluid (76).

Those of ordinary skill in the art will recognize that several variables can be controlled to modify the system. By increasing the voltage delta between the static electrode and the dielectric assembly, one can increase the quantity or dose of plasma generated. Furthermore, increasing the surface area of the static electrode, or increasing the surface area of the static electrode being adjacent to the dielectric assembly, yields a greater surface area of fluid to be treated. Furthermore, the surface area of the dielectric assembly can be increased or decreased by increasing or decreasing its size such as length or diameter. Furthermore, variations of the surface of the dielectric assembly (24) can modify the quantity of fluid being created as a thin film, e.g., as depicted in FIG. 4C. Finally, the speed of rotation of the dielectric assembly will modify the quantity of fluids being treated. Accordingly, the rate of production of charged fluids can be modified by modifications of these variables as would be understood by those of ordinary skill in the art.

Referring to FIG. 7B, in a further embodiment, the plasma-treated thin film (74) can be removed from the apparatus, for example, with a blade (78), which is positioned adjacent to the dielectric assembly (24) and shaves off or diverts at least a portion of the plasma-treated thin film (74) before it returns to the reservoir (26) through a collection channel (79) and to a storage vessel for collection. A blade (78) is an edge designed to separate the plasma treated thin film (74) of fluid from the rotating dielectric assembly (24). Such a blade (78) could be a rubber, plastic, metal, or other object that is stationary or movable to diverge and separate the plasma-treated thin film (74) from the dielectric assembly (24). For example, the collection channel (79) may be used to directly bottle the plasma-treated thin film (74) or dump it onto a collection container for subsequent use. As the fluid (76) is drawn from the reservoir (26) out of the collection channel (79), fluids (76) are replaced into the reservoir (26) to maintain the level of the fluid (76) within the reservoir (26). Thus, the fluids (76) in the reservoir (26) are mostly untreated fluids (76), though some amounts of plasma-treated fluids may pass the blade (78) and are returned into the reservoir (26) and are passed over the rotating dielectric assembly (24), for plasma treatment and subsequent collection.

As volumes of fluid to be treated become greater, it may be advantageous to create additional elements on the dielectric assembly (24) to increase the movement of fluid within the reservoir. Embodiments depicted in FIGS. 4A, 4B, and 4C detail various approaches to move greater volumes of fluid within the reservoir. For example, FIG. 4A depicts a dielectric assembly (400) comprising four different paddles (406), each containing a bucket (408), which functions much like a water wheel, with the purpose of moving large volumes of fluid within the reservoir. Although four paddles (406) are shown, embodiments are not limited thereto. Each paddle (406) has a length and a width and is attached to the dielectric assembly (400) at one end and has a bucket (408) attached to the other end. Each bucket (408), in turn, has a diameter (or width and length if not circular) and a height. The dimensions of the bucket (408) generally correspond to that of the corresponding paddle (406). That is, the bucket (408) may be any size as long as the corresponding paddle (406) is sized to support the bucket (408). Moreover, the dimensions of the paddles (406) and buckets (408) should not substantially interfere with the functionality of the dielectric assembly (400). The dielectric assembly (402) shown in FIG. 4B utilizes several fins (410) positioned at each end of opposing ends of the cylindrical dielectric assembly (402). The exact number, size, shape, and attachment arrangement of each fin (410) may be modified as desired. Finally, FIG. 4C depicts a paddle face dielectric assembly (404) with a plurality of raised ridges (412) on the curved face of the paddle face dielectric assembly (404). With raised ridges (412), as dielectric assembly (404) rotates, the paddle face dielectric (404) moves additional fluids. Certainly, the various approaches function differently based on the viscosity of the fluid being treated, and those of appropriate skill in the art can modify the device and utilize an appropriate dielectric based on the particular fluid, volume, and time for the particular fluid.

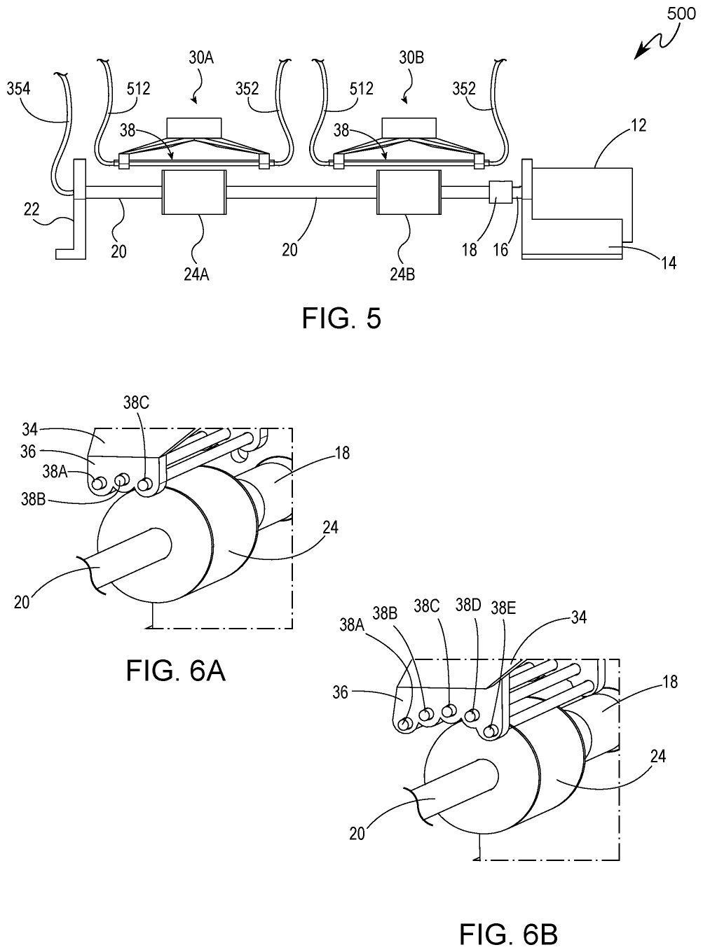

A further embodiment of a plasma generating device (500) is depicted in FIG. 5. As is shown in the figure, the plasma generating device (500) includes a motor (12), a support structure (14) an output shaft (16), a connector (18) a rotating shaft (20), and an opposing sidewall (22) that are all the same as or similar to the those shown in the other figures. The plasma generating device (500) however, includes two or more dielectric assemblies (24A, 24B) each with a corresponding electrode holder (30A, 30B) that holds one or more electrodes (38) equidistant from the dielectric assembly (24). Each dielectric assembly (24A, 24B) is the same as or similar to an embodiment of the dielectric assembly (24) discussed herein. Likewise, each electrode holder (30A, 30B) and static electrode (38) are the same as or similar to an embodiment of the electrode holder (30) and one or more static electrodes (38) discussed herein. Notably, both dielectric assemblies (24A, 24B) positioned along a longitudinal axis of the rotating shaft are separated from one another by a distance. As such, both electrode holders (30A, 30B) and one or more electrodes (38) being held thereby are properly positioned equidistant and adjacent to respective dielectric assemblies (24A, 24B) to enable plasma generation. As is shown in the figure, the electrodes (38) in each electrode holder (30A, 30B) are separately connected to a high voltage generator or generators (not shown) via a corresponding wire/wiring harness (352), which may be considered a positive wire. Similarly, each static electrode (38), via its holder (30) may be grounded via a positive wire (512) to create a circuit with the electrode. A positive wire (512) is also available to other embodiments of the plasma-generating device (10). Last, a ground wire (354) may also be present to ground the dielectric assemblies (24A, 24B), to ground the rotating shaft (20) or both. Scaled up versions of these devices (500) may include numerous dielectrics assemblies (24) positioned on a rotating shaft (20), each with several electrodes (38) positioned adjacent thereto, thus allowing for large volumes of fluid to be plasma treated at once. Indeed, the quantity of dielectric assemblies (24) and the number of electrodes (38) allows for scaling up of the possible volume of plasma-treated fluids.

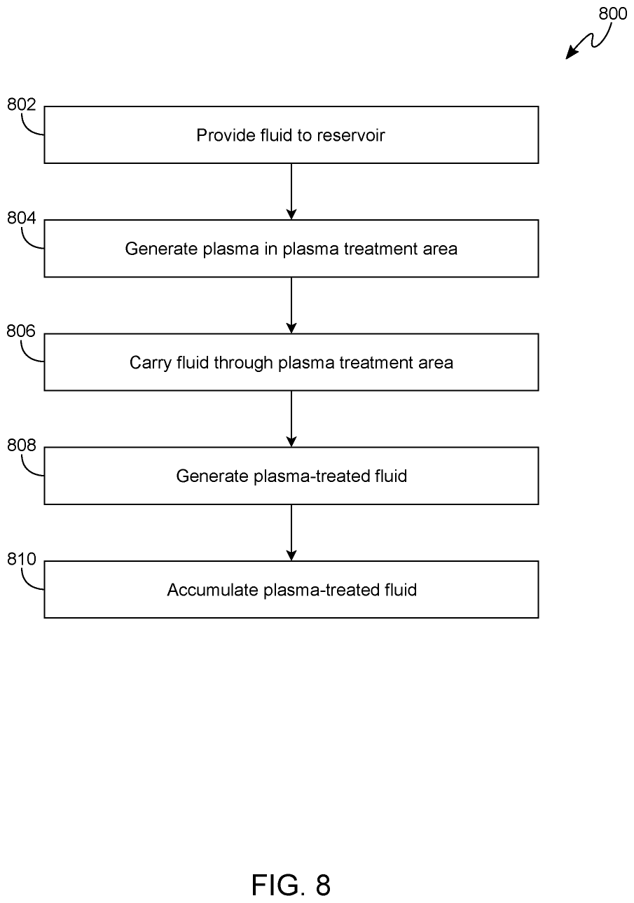

FIG. 8 details an embodiment of a method (800) for generating a plasma treated fluid. Generally, a given quantity of fluid is added to the reservoir (26) and at the beginning of treatment (step 802) and remains in the reservoir until it has reached a desired treatment level. Alternatively, a given quantity of fluid may be added to the reservoir (26) before treatment begins (step 802), and that quantity is substantially maintained by adding fluid to the reservoir (26) to offset removal of plasma-treated fluid before it is returned to the reservoir (26) after treatment. Fluids that may be treated include, without limitation, water, oils, alcohols, epoxies, paints, hydrogels, pharmaceutical fluids, polymers, polymer mixtures, and the like. Furthermore, one or more additives may be added to the fluid. Additives include, without limitation, peracetic acid, chloride-based disinfectants, alcohols, sodium nitrate, and combinations thereof. These additives may be mixed into the fluid to have a concentration of from about 0.01 mM to about 5 M, including the endpoints. Hydrogen peroxide may be added to the fluid to have a concentration of from about 0.01% to about 10%. Hydrogen peroxide may be used in combination with one or more of the aforenamed additives. As one example, hydrogen peroxide (about 0.01% to about 10%) and peracetic acid (from about 0.01 mM to about 250 mM) may both be added to a fluid such as water. In certain applications, an additive may be a radical donor, which is a material that, in the presence of the plasma, generates high quantities of highly reactive radicals. In fact, a particularly useful embodiment of a treated fluid includes water having a sodium nitrate added thereto at a concentration of from 1 mM to about 100 mM, with a preferred concentration of about 25 millimolar (mM).

The fluid is carried through a plasma treatment area by the rotational electrode (42)/dielectric assembly (24). Generally, the plasma treatment area is defined by the dimensions of the rotational electrode (42)/dielectric assembly (24) and the one or more static electrodes (38). For example, the length of the treatment area can be about the same as the length of the rotational electrode (42)/dielectric assembly (24) and the diameter of the same will influence the width of the treatment area. Similarly, the length of the one or more static electrodes (38) will also help define the treatment area. Namely, the plasma treatment area is limited by whichever has the shortest length, the rotational electrode (42)/dielectric assembly (24) or the one or more static electrodes (38). The overall width of the one or more static electrodes (38) will also affect the width of the treatment area. Thus, the width of the treatment area may be affected by the number and/or diameter of elongate rods and by the width of a sheet. Furthermore, the treatment area may be maximized by disposing the one or more static electrodes (38) in an arc over the curved surface of the rotational electrode (42)/dielectric assembly (24).

The plasma is generated in the plasma treatment area (step 804) by providing a voltage difference between the rotational electrode (42) and the one or more static electrodes (38). This voltage difference can be created by having a voltage applied to one of the rotational electrodes (42) or the one or more static electrodes (38) and having the other serve as a ground, or a voltage (e.g., positive and/or negative) may be applied to both of the rotational electrode (42) and the one or more static electrodes (38). What is important is that there is a delta of the voltage between the voltage from the one or more static electrodes to the dielectric assembly/rotational electrode. In a preferred embodiment, the voltage delta is the range of from 500 volts to 200,000 volts, and more preferably between 1000 volts and 50,000 volts. In a further embodiment, the voltage is pulsed between 10 Hz and 40,000 Hz with amplitude of 5 kV to 50 kV. Preferred frequency is 500 Hz to 10,000 Hz and voltage amplitude of 10 kV to 50 kV. Thus, the dosing of the fluid treated by the plasma (e.g., “plasma dosing”) may be influenced by one or more factors including, without limitation, the size of the treatment area, the voltage difference, the rotating speed, and the surface area of the rotational electrode (42)/dielectric assembly (24).

To treat the fluid, the motor (12) is turned on to rotate the rotating shaft (20), hence rotational electrode (42). In an embodiment, the rotational electrode (42) is incorporated into the dielectric assembly (24). As the dielectric assembly (24) rotates at the desired speed within the fluid, a portion of the dielectric assembly (24) surface is continuously in contact with the fluid (e.g., a contact portion [28]). Thus, as the dielectric assembly (24) rotates through the fluid, a thin film of fluid is carried with the rotating dielectric assembly (24) toward and through the treatment area (72) as is indicated at step (806). Thereafter, the treated film of fluid may be returned to the reservoir (26), where it may react with other molecules to produce additional reactive species as it intermixes with the fluid within the reservoir (26), or it may be diverted by the blade assembly (78) for collection before being returned to the reservoir (26), which is indicated at step (810). Either way, the generated plasma-treated fluid (step 808) may be used almost immediately, or it may be stored for later use.

As one nonlimiting example, where sodium nitrate is added to a fluid (e.g., water) at a concentration of between 1 mM and 100 mM, the resultant plasma-treated fluid may contain high concentrations of peroxynitrate, which is a strong oxidizer. As another nonlimiting example, an additive can be sufficient to generate plasma-treated fluid that has a greater than 1-log reduction in the rate of killing of E. coli, as compared to the same fluid without the additive. For example, the addition of 25 mM sodium nitrate results in a plasma-treated fluid that has greater than 1-log kill rate of E. coli, as compared to a fluid without the 25 mM addition. In other nonlimiting examples, plasma-treated fluids may be generated that have a desired pH (e.g., from about 2 to about 4.5), a desired concentration of radicals/reactive species such as H₂O₂ (e.g., between 10 ppm and 200 ppm), NO₃⁻ (e.g., between 20 and 500), and combinations thereof.

In an embodiment, storage of plasma treated fluid may include cooling or even freezing or flash freezing the plasma-treated fluid (for example, as soon as is practicable), which may extend its shelf life. In a further embodiment, used plasma treated fluid may be saved for eventual recycling through the device (10). It is foreseeable that used fluid may need to be filtered to remove dirt/debris before being recycled. Even so, the ability to recycle fluid may provide a huge savings and reduce the environmental toll for industrial applications that use and discard vast quantities of fluid such as washing produce or meat.

### EXAMPLES

The rotation of the dielectric assembly (24) to bring the fluid to the plasma treatment area between the dielectric assembly (24) and the one or more static electrodes (38) modifies the properties of the fluid being treated. In the example described below, tap water was plasma treated in open air atmosphere using an embodiment of the plasma generating device (10). As is shown in Table 1, below, the most notable changes to the water are those to the pH and concentrations of certain radicals within the fluid, for example hydrogen peroxide H₂O₂ and nitrate (NO₃⁻). To test the efficacy of the model, a device (10) using a single static electrode (38) and a single dielectric assembly (24) having a length of either 30 millimeters (mm) or 60 mm was placed into a reservoir (26) with tap water and rotated at speeds of 10, 60, 120, and 300 rotations per minute (RPM), for between 30 and 60 minutes. The voltage between the rotational electrode (42) and the static electrode (38) was 22 kV. pH measurements were taken before treatment (time=0) and at 5, 10, 20, 45, and 60 minutes of processing through the generated plasma. Hydrogen peroxide and nitrate measurements were taken after 60 minutes of treatment, as is noted in Table 1 below.

TABLE 1

| | pH | | | | | | | |
|---|---|---|---|---|---|---|---|---|
| | Time (min) | | | | | | H₂O₂ | NO₃⁻ |
| Electrode, speed | 0 | 5 | 10 | 20 | 45 | 60 | ppm | ppm |
| 30 mm, 10 RPM | 6 | 5 | 4 | 3.5 | 3 | 3 | 10 | 20 |
| 60 mm, 10 RPM | 6 | 4.5 | 4 | 3.5 | 2.5 | 2.5 | 50 | 50 |
| 30 mm, 60 RPM | 6 | 4 | 4 | 3.5 | 3 | 2.5 | 25 | 50 |
| 60 mm, 60 RPM | 6 | 4 | 3.5 | 3 | 3 | 3 | 50 | 50 |
| 30 mm, 120 RPM | 6 | 4 | 4 | 3.5 | 3 | 3 | 50 | 100 |
| 60 mm, 120 RPM | 6 | 4 | 3.5 | 3.5 | 3 | 2.5 | 100 | 250 |
| 30 mm, 300 RPM | 6 | 4 | 4 | 3.5 | 3 | 2.5 | 50 | 250 |

| | | | | |
|---|---|---|---|---|
| 30 mm, 300 RPM | Indigo Carmine Treatment is 120 min | 2 | 100 | 50 |

As can be seen by the data shown in Table 1, the pH of the water decreased over time, which indicates that reactive species (e.g., hydrogen ions) are being produced by plasma treating the water with the device (10). Moreover, the presence of other reactive species (e.g., H₂O₂, NO₃⁻) also confirms that the device (10) can successfully plasma treat a fluid.

As is also indicated in Table 1, confirmation of the oxidative potential is shown by the oxidation of indigo carmine. In the examiner, the plasma generating device (10) generates sufficient oxidation species to oxidate the indigo carmine. For example, an indigo carmine solution was a dark purple color before treatment, but after 120 minutes of treatment with the plasma generating device (10) the solution in the reservoir turned clear, which is an indicator of a change in oxidative state.

A further test was performed utilizing the blade (78) assembly as detailed in FIG. 7B. The blade (78) allows the treated thin-film fluid (74) to be pulled off of the dielectric assembly (24) and captured in a container other than the reservoir (26) while new fluid (e.g., tap water) was added to the reservoir (26) to maintain a given volume of water within the reservoir (26). Thus, treated fluids were drained off of the dielectric assembly (24) and captured in a collection container. Several different samples were tested, and each of the samples revealed a pH of 2.75±0.15, and a concentration of H₂O₂ of between 50 ppm and 100 ppm, as well as a NO₃⁻ concentration of between 125 ppm and 250 ppm. Notably, this was consistent with the results gathered from the test samples in Table 1. Thus, use of the blade (78) assembly enables the rapid and continuous treatment of fluids by the device (10). As was demonstrated by the data in Table 1, a change in pH and the presence of other reactive species depends on the plasma residency time, the plasma dosage, or both. Plasma residency time and dosage may be altered by a change in a voltage difference between the rotational electrode and the one or more static electrodes, a change in the size of the rotational electrode, the one or more static electrodes, or both, a change in the frequency of the voltage being applied, a change in rotational speed of the rotational electrode, and combinations thereof, as will be appreciated by those of ordinary skill in the art.

Accordingly, the device as detailed herein is able to dramatically scale up the production of plasma-treated fluids. While treatment of the fluids remains relatively static (e.g., at the treatment area), the capture process for the plasma-treated fluids can be modified to process in bulk, i.e., in the protocol as outlined for the materials in Table 1, or it can utilize a blade (78) assembly to continuously capture treated fluids off of the dielectric assembly/rotational electrode. Either way, a plasma generating device (10) as describe herein is able to scale production of plasma-treated fluids, and which can be modified to meet the particular needs, i.e., lower or higher concentrations of H₂O₂ or NO₃⁻, as well as other radicals therein based upon the treatment conditions.

The device, therefore, is able to generate plasma-treated fluids having concentrations of radicals that allow for sale production of plasma-treated fluids. The plasma-treated fluids may have a pH of between about 2 and about 4.5, with concentrations of radicals, for example H₂O₂ at between 10 ppm and 200 ppm, and concentration of NO₃⁻ at between 20 and 500, including all numbers and ranges in between. However, the presence of additional radicals is likely present in treated fluids.

What is claimed is:

1. A plasma generating device comprising:
a static electrode and a rotational electrode;
a dielectric positioned therebetween said static electrode and said rotational electrode;
a shaft along a longitudinal axis of said rotational electrode;
a motor operationally connected to said shaft; and
a high voltage generator connected to at least one of the static electrode or rotational electrode.

2. The plasma generating device of claim 1 further comprising a fluid reservoir, said fluid reservoir positioned below said rotational electrode.

3. (canceled)

4. The plasma generating device of claim 1 wherein said dielectric is positioned on said static electrode or said rotational electrode.

5. (canceled)

6. The plasma generating device of claim 1 wherein the high voltage generator defines a voltage difference of between and including 500 volts and 200,000 volts across the static electrode and the rotational electrode sufficient to generate plasma.

7. (canceled)

8. The plasma generating device of claim 1 wherein said rotational electrode is a cylindrically shaped rotational electrode.

9. The plasma generating device of claim 8 wherein said static electrode is an arcuate shape, said arcuate shape being defined by the size and shape of the cylindrically shaped rotational electrode.

10. (canceled)

11. The plasma generating device of claim 2 wherein said fluid reservoir comprises a volume of fluid, said volume of fluid sufficient such that the rotational electrode is in contact with at least a portion of said fluid.

12. The plasma generating device of claim 1 wherein a fluid moving element is positioned on said rotational electrode.

13. The plasma generating device of claim 1 wherein said dielectric defines a plurality of ridges, said plurality of ridges being substantially aligned along the longitudinal axis of the rotational electrode.

14. The plasma generating device of claim 11 wherein said fluid is selected from the group consisting of: water, an oil, an alcohol, an epoxy, a paint, a polymer, a mixture of polymers, and combinations thereof.

15. (canceled)

16. A plasma generating device comprising:
a cylindrical rotational electrode situated lengthwise on a rotating shaft connected to a motor, the rotational electrode disposed over a reservoir and having a contact portion extending into the reservoir;
at least one static electrode held in proximity to the rotational electrode to generate a plasma therebetween when a sufficient voltage difference exists between the at least one static electrode and the rotational electrode, the sufficient voltage difference created by a high voltage generator connected directly or indirectly to the at least one static electrode, the rotational electrode, or both; and
a dielectric material situated between the rotational electrode and the at least one static electrode, the dielectric material having a sufficient thickness to prevent a short-circuit between the rotational electrode and the at least one static electrode yet a minimal thickness to allow the plasma to be generated between the rotational electrode and the at least one static electrode.

17. The plasma generating device of claim 16 comprising at least two static electrodes, said at least two static electrodes secured by an electrode holder to maintain equidistance between each static electrode and the rotational electrode.

18. The plasma generating device of claim 16 wherein the static electrode having an arcuate shape that complements a cylindrical surface of the rotational electrode to maintain equidistance between the static electrode and the rotational electrode.

19. (canceled)

20. The plasma generating device of claim 16 wherein the dielectric material is disposed on the rotational electrode, the at least one static electrode, or both.

21. The plasma generating device of claim 16 further comprising a sidewall having a bearing disposed therein to rotationally support an end of the rotating shaft that extends through the bearing and that is opposite an end connected to the motor.

22. The plasma generating device of claim 16 wherein the rotational electrode includes a fluid moving element selected from the group consisting of: a bucket-ended paddle, a fin, a raised ridge, and combinations thereof; and wherein the fluid moving element is positioned on or adjacent to the rotational electrode and radiating out from the rotational electrode.

23. (canceled)

24. The plasma generating device of claim 16 further comprising a blade oriented proximate the rotational electrode to divert a fluid for collection after the fluid has passed through the plasma.

25. (canceled)

26. (canceled)

27. A method of generating a plasma-treated fluid comprising:
providing a fluid to a reservoir;
rotating a rotational electrode through the fluid in the reservoir to continuously deliver a portion of the fluid through a plasma treatment area created by a pulsing voltage between and including 10 Hz and 40,000 Hz with an amplitude of between and including 5 kV to 50 kV and having a voltage difference of between and including 500 volts and 200,000 volts between the rotational electrode and at least one static electrode that is positioned adjacent to the rotational electrode to maximize the plasma treatment area; and
accumulating a generated plasma-treated fluid that is the result of rotating the portion of the fluid through the plasma treatment area.

28. (canceled)

29. (canceled)

30. (canceled)

31. The method of claim 27 wherein accumulating the plasma-treated fluid comprises either returning the plasma-treated fluid to the reservoir to intermix with the fluid already in the reservoir or diverting the plasma-treated fluid to a collection container.

32. The method of claim 27 wherein providing a fluid to the reservoir includes providing a fluid containing an additive that will produce a plasma-treated fluid having a desired property.

33. The method of claim 32 wherein the additive is selected from the group consisting of: peracetic acid, a chlorine-based disinfectant, an alcohol, hydrogen peroxide, sodium nitrate, and combinations thereof.

34. (canceled)

35. (canceled)

36. (canceled)

37. (canceled)

38. The method of claim 27 wherein the generated plasma-treated fluid has a pH of between and including 2 and 5 after passing through the plasma treatment area.

39. (canceled)

40. (canceled)

41. The method of claim 27 comprising collecting a portion of plasma-treated fluid by diverting a portion of the plasma-treated fluid with a blade oriented adjacent to the rotational electrode and downstream of the plasma treatment area and causing a portion of the plasma-treated fluid to be diverted across the blade for collection.

42. (canceled)

43. (canceled)

44. (canceled)

45. (canceled)
